(19) United States
(12) Patent Application Publication
(10) Pub. No.: US 2016/0308768 A1
(43) Pub. Date: Oct. 20, 2016

(54) ELECTRONIC DEVICE AND METHOD FOR OPERATING COMMUNICATION OF THE SAME

(71) Applicant: SAMSUNG ELECTRONICS CO., LTD., Suwon-si (KR)

(72) Inventors: Suha YOON, Seoul (KR); Eun-Seok RYU, Seoul (KR); Euichang JUNG, Seoul (KR); Suyoung PARK, Uiwang-si (KR)

(21) Appl. No.: 15/131,247

(22) Filed: Apr. 18, 2016

(30) Foreign Application Priority Data
Apr. 16, 2015 (KR) 10-2015-0053961

(51) Int. Cl. H04L 12/801; H04W 48/16; H04L 29/08; H04W 24/08; H04W 52/02; H04W 76/04; H04W 48/18

(52) U.S. Cl. CPC H04L 47/11; H04W 76/043; H04W 48/16; H04W 48/18; H04W 24/08; H04W 52/0261; H04L 67/104; H04W 88/06

(57) ABSTRACT

A method for operating communication of an electronic device is provided, which includes determining whether a network is in a congestion state, and changing a communication operation state if the network is in the congestion state.

### PRIORITY

This application is based on and claims priority under 35 U.S.C. §119 to Korean patent application filed on Apr. 16, 2015, in the Korean Intellectual Property Office and assigned Serial No. 10-2015-0053961, the disclosure of which is incorporated by reference herein in its entirety.

### BACKGROUND

1. Field

The present disclosure relates to an electronic device and a method for operating communication of the same, which can cope with a network congestion situation in the case where network congestion occurs.

2. Description of Related Art

With the abrupt increase of various information communication devices, such as smart phones and tablet PCs, the amount of data communication is on an increasing trend. Due to an abrupt increase of the amount of data communication, network congestion may occur.

Due to the occurrence of network congestion of an electronic device, buffering phenomenon, call quality deterioration, and call transmission/reception inferiority may occur during data transmission/reception.

### SUMMARY

In various example embodiments of the present disclosure, an electronic device and a method for operating communication of the same can provide various communication operation methods when network congestion occurs.

In accordance with an aspect of the present disclosure, a method for operating communication of an electronic device includes determining whether a network is in a congestion state; and changing a communication operation state if the network is in the congestion state.

In accordance with another aspect of the present disclosure, an electronic device includes a communication module; and a processor, wherein the processor is configured to determine whether a network is in a congestion state using a network congestion determination module, and changes a communication operation state if the network is in the congestion state.

According to various example embodiments of the present disclosure, since the electronic device and the method for operating communication of the same can provide various communication operation methods when the network congestion occurs, communication resources of the electronic device can be efficiently used, and the network congestion situation can be mitigated or reduced.

### BRIEF DESCRIPTION OF THE DRAWINGS

The above and/or other aspects will become apparent and more readily appreciated from the following detailed description, taken in conjunction with the accompanying drawings, in which like reference numerals refer to like elements, and wherein:

FIG. 1 is a block diagram illustrating an example network environment including an electronic device according to an embodiment of the present disclosure;

FIG. 2 is a block diagram illustrating an example electronic device according to various embodiments of the present disclosure;

FIG. 3 is a block diagram illustrating an example program module according to various embodiments of the present disclosure;

FIG. 4 is a flowchart illustrating an example method for operating communication of an electronic device according to various embodiments of the present disclosure;

FIG. 5 is a flowchart illustrating an example method for determining a target operator in the case where an electronic device according to various embodiments of the present disclosure includes a UICC that is detachably attached to a UICC module;

FIG. 6 is a flowchart illustrating an example method for determining a target operator in the case where an electronic device according to various embodiments of the present disclosure includes a UICC that is embedded in a UICC module;

FIG. 7 is a diagram illustrating an example state machine regarding profile installation and activation in an electronic device including an embedded UICC according to various embodiments of the present disclosure;

FIG. 8 is a flowchart illustrating an example profile activation of a target operator in an electronic device including an embedded UICC according to various embodiments of the present disclosure;

FIG. 9 is a diagram illustrating an example method for operating communication of an electronic device according to various embodiments of the present disclosure;

FIG. 10 is a flowchart illustrating an example method for operating communication of an electronic device according to various embodiments of the present disclosure;

FIG. 11 is a flowchart explaining a method for operating communication of an electronic device according to various embodiments of the present disclosure;

FIG. 12 is a flowchart illustrating an example method for operating communication of an electronic device according to various embodiments of the present disclosure;

FIG. 13 is a diagram illustrating an example antenna mode change of an electronic device according to various embodiments of the present disclosure;

FIG. 14 is a diagram illustrating an example antenna mode change of an electronic device according to various embodiments of the present disclosure;

FIG. 15 is a flowchart illustrating an example method for operating communication of an electronic device according to various embodiments of the present disclosure;

FIG. 16 is a flowchart illustrating an example D2D scanning method of an electronic device according to various embodiments of the present disclosure;

FIG. 17 is a flowchart illustrating an example D2D scanning method of an electronic device according to various embodiments of the present disclosure;

FIG. 18 is a flowchart illustrating an example D2D scanning method of an electronic device according to various embodiments of the present disclosure; and

FIG. 19 is a flowchart illustrating an example D2D scanning method of an electronic device according to various embodiments of the present disclosure.

### DETAILED DESCRIPTION

Hereinafter, the present disclosure will be described with reference to the accompanying drawings. Although example embodiments are illustrated in the drawings and related detailed descriptions are discussed in the present specification, the present disclosure may have various modifications and several embodiments. However, various embodiments of the present disclosure are not limited to a specific implementation form and it should be understood that the present disclosure includes all changes and/or equivalents and substitutes included in the spirit and scope of various embodiments of the present disclosure. In connection with descriptions of the drawings, similar components are designated by the same reference numeral.

The term “include” or “may include” which may be used in describing various embodiments of the present disclosure refers to the existence of a corresponding disclosed function, operation or component which can be used in various embodiments of the present disclosure and does not limit one or more additional functions, operations, or components. In various embodiments of the present disclosure, the terms such as “include” or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

In various embodiments of the present disclosure, the expression “or” or “at least one of A or/and B” includes any or all of combinations of words listed together. For example, the expression “A or B” or “at least A or/and B” may include A, may include B, or may include both A and B.

The expression “1”, “2”, “first”, or “second” used in various embodiments of the present disclosure may modify various components of the various embodiments but does not limit the corresponding components. For example, the above expressions do not limit the sequence and/or importance of the components. The expressions may be used for distinguishing one component from other components. For example, a first user device and a second user device indicate different user devices although both of them are user devices. For example, without departing from the scope of the present disclosure, a first structural element may be referred to as a second structural element. Similarly, the second structural element also may be referred to as the first structural element.

When it is stated that a component is “coupled to” or “connected to” another component, the component may be directly coupled or connected to another component or a new component may exist between the component and another component. In contrast, when it is stated that a component is “directly coupled to” or “directly connected to” another component, a new component does not exist between the component and another component.

The terms used in describing various embodiments of the present disclosure are only examples for describing a specific embodiment but do not limit the various embodiments of the present disclosure. Singular forms are intended to include plural forms unless the context clearly indicates otherwise.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present description.

An electronic device according to various embodiments of the present disclosure may be a device including a communication function. For example, the electronic device may be one or a combination of a smart phone, a tablet Personal Computer (PC), a mobile phone, a video phone, an e-book reader, a desktop PC, a laptop PC, a netbook computer, a Personal Digital Assistant (PDA), a camera, a wearable device (for example, a Head-Mounted-Device (HMD) such as electronic glasses, electronic clothes, and electronic bracelet, an electronic necklace, an electronic appcessary, an electronic tattoo, and a smart watch, or the like.

According to some embodiments, the electronic device may be a smart home appliance having a communication function. The smart home appliance may include at least one of a TeleVision (TV), a Digital Video Disk (DVD) player, an audio player, an air conditioner, a cleaner, an oven, a microwave oven, a washing machine, an air cleaner, a set-top box, a TV box (for example, Samsung HomeSync™, Apple TV™, or Google TV™), game consoles, an electronic dictionary, an electronic key, a camcorder, and an electronic frame, or the like.

According to some embodiments, the electronic device may include at least one of various types of medical devices (for example, Magnetic Resonance Angiography (MRA), Magnetic Resonance Imaging (MRI), Computed Tomography (CT), a scanner, an ultrasonic device and the like), a navigation device, a Global Positioning System (GPS) receiver, an Event Data Recorder (EDR), a Flight Data Recorder (FDR), a vehicle infotainment device, electronic equipment for a ship (for example, a navigation device for ship, a gyro compass and the like), avionics, a security device, a head unit for a vehicle, an industrial or home robot, an Automatic Teller Machine (ATM) of financial institutions, and a Point Of Sale (POS) device of shops, or the like.

According to some embodiments, the electronic device may include at least one of furniture or a part of a building/structure, an electronic board, an electronic signature receiving device, a projector, and various types of measuring devices (for example, a water meter, an electricity meter, a gas meter, a radio wave meter and the like) including a camera function, or the like. The electronic device according to various embodiments of the present disclosure may be one or a combination of the above described various devices. Further, the electronic device according to various embodiments of the present disclosure may be a flexible device. It is apparent to those skilled in the art that the electronic device according to various embodiments of the present disclosure is not limited to the above described devices.

Hereinafter, an electronic device according to various embodiments of the present disclosure will be described with reference to the accompanying drawings. The term “user” used in various embodiments may refer to a person who uses an electronic device or a device (for example, an artificial intelligence electronic device) which uses an electronic device.

According to one embodiment of the present disclosure, a screen of an electronic device may be split into at least two windows according to a predefined split manner and displayed through a display of an electronic device. The windows are defined as split windows. According to one embodiment, the split windows are defined as windows displayed on a display of an electronic display not to be superposed one on another.

According to one embodiment, a popup window is defined as a window displayed on a display of an electronic device to hide or to be superposed on a portion of a screen under execution.

According to one embodiment of the present disclosure, an electronic device using split window and a popup window is capable of displaying two or more application execution screens or function execution screens. Thus, the split windows and the popup window are defined as a multi-window.

Hereinafter, an electronic device according to various embodiments will be described with reference to the accompanying drawings. As used herein, the term “user” may indicate a person who uses an electronic device or a device (e.g., an artificial intelligence electronic device) that uses an electronic device.

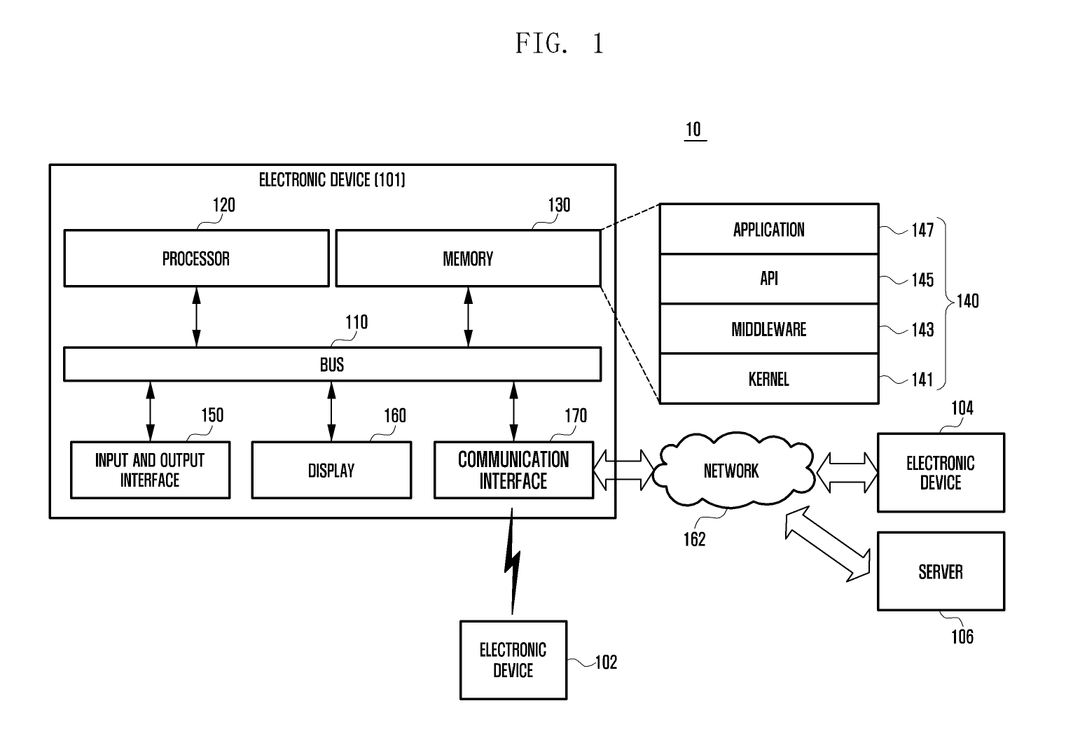

FIG. 1 illustrates a network environment 10 including an electronic device 101 according to various embodiments of the present disclosure. Referring to FIG. 1, the electronic device 100 includes a bus 110, a processor (e.g., including processing circuitry) 120, a memory 130, an input/output interface 150, a display 160 and a communication interface 170.

The bus 110 may be a circuit connecting the above described components and transmitting communication (for example, a control message) between the above described components. The processor 120 receives commands from other components (for example, the memory 130, the input/output interface 150, the display module 160, the communication interface 170) through the bus 110, analyzes the received commands, and executes calculation or data processing according to the analyzed commands. The memory 130 stores commands or data received from the processor 120 or other components (for example, the input/output interface 150, the display module 160, or the communication interface 170) or generated by the processor 120 or other components. The memory 130 may include programming modules 140, for example, a kernel 141, middleware 143, an Application Programming Interface (API) 145, and an application 147. Each of the aforementioned programming modules may be implemented by software, firmware, hardware, or a combination of two or more thereof.

The kernel 141 controls or manages system resources (for example, the bus 110, the processor 120, or the memory 130) used for executing an operation or function implemented by the remaining other programming modules, for example, the middleware 143, the API 145, or the application 147. Further, the kernel 141 provides an interface for accessing individual components of the electronic device 101 from the middleware 143, the API 145, or the application 147 to control or manage the components. The middleware 143 performs a relay function of allowing the API 145 or the application 147 to communicate with the kernel 141 to exchange data. Further, in operation requests received from the application 147, the middleware 143 performs a control for the operation requests (for example, scheduling or load balancing) by using a method of assigning a priority, by which system resources (for example, the bus 110, the processor 120, the memory 130 and the like) of the electronic device 100 can be used, to the application 134.

The API 145 is an interface by which the application 147 can control a function provided by the kernel 141 or the middleware 143 and includes, for example, at least one interface or function (for example, command) for a file control, a window control, image processing, or a character control. The input/output interface 150 can receive, for example, a command and/or data from a user, and transfer the received command and/or data to the processor 120 and/or the memory 130 through the bus 110. The display 160 can display an image, a video, and/or data to a user.

According to an embodiment, the display 160 may display a graphic user interface image for interaction between the user and the electronic device 100. According to various embodiments, the graphic user interface image may include interface information to activate a function for correcting color of the image to be projected onto the screen. The interface information may be in the form of, for example, a button, a menu, or an icon. The communication interface 170 connects communication between the electronic device 100 and the external device (for example, electronic device 102, 104 or server 106). For example, the communication interface 170 may access a network 162 through wireless or wired communication to communicate with the external device. The wireless communication includes at least one of, for example, WiFi, BlueTooth (BT), Near Field Communication (NFC), a Global Positioning System (GPS), and cellular communication (for example, LTE, LTE-A, CDMA, WCDMA, UMTS, WiBro or GSM). The wired communication may include at least one of, for example, a Universal Serial Bus (USB), a High Definition Multimedia Interface (HDMI), Recommended Standard 232 (RS-232), and a Plain Old Telephone Service (POTS).

According to an embodiment, the server 106 supports driving of the electronic device 100 by performing at least one operation (or function) implemented by the electronic device 100. For example, the server 106 may include a communication control server module that supports the communication interface 170 implemented in the electronic device 100. For example, the communication control server module may include at least one of the components of the communication interface 170 to perform (on behalf of) at least one operations performed by the communication interface 170.

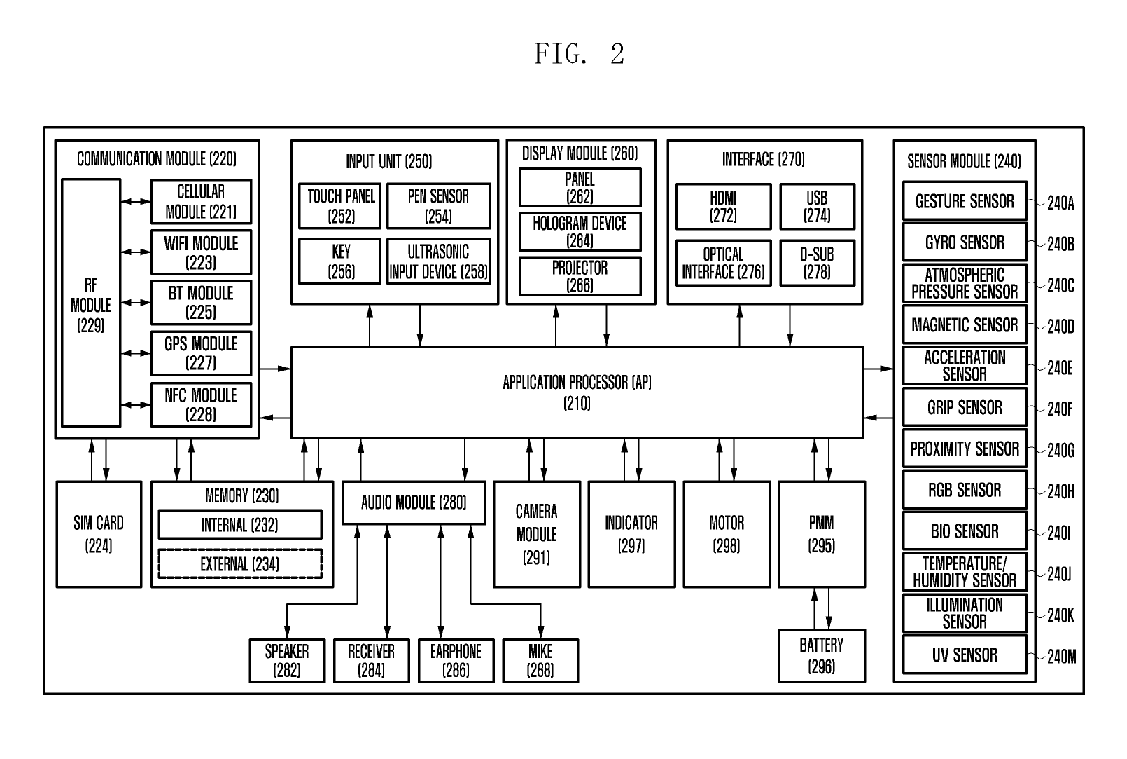

FIG. 2 is a block diagram 200 illustrating an example electronic device 200 according to various embodiments of the present disclosure. The electronic device 200 may configure, for example, a whole or a part of the electronic device 100 illustrated in FIG. 1. Referring to FIG. 2, the electronic device 200 includes one or more Application Processors (APs) 210, a communication module 220, a Subscriber Identification Module (SIM) card 224, a memory 230, a sensor module 240, an input device 250, a display 260, an interface 270, an audio module 280, a camera module 291, a power managing module 295, a battery 296, an indicator 297, and a motor 298.

The AP 210 operates an operating system (OS) or an application program so as to control a plurality of hardware or software component elements connected to the AP 210 and execute various data processing and calculations including multimedia data. The AP 210 may be implemented by, for example, a System on Chip (SoC). According to an embodiment, the processor 210 may further include a Graphic Processing Unit (GPU).

The communication module 220 (for example, communication interface 170) transmits/receives data in communication between different electronic devices (for example, the electronic device 104 and the server 106) connected to the electronic device 200 (for example, electronic device 100) through a network. According to an embodiment, the communication module 220 includes a cellular module 221, a WiFi module 223, a BlueTooth (BT) module 225, a Global Positioning System (GPS) module 227, a Near Field Communication (NFC) module 228, and a Radio Frequency (RF) module 229.

The cellular module 221 provides a voice, a call, a video call, a Short Message Service (SMS), or an Internet service through a communication network (for example, Long Term Evolution (LTE), LTE-A, Code Division Multiple Access (CDMA), Wideband CDMA (WCDMA), UMTS, WiBro, GSM or the like). Further, the cellular module 221 may distinguish and authenticate electronic devices within a communication network by using a subscriber identification module (for example, the SIM card 224). According to an embodiment, the cellular module 221 performs at least some of the functions which can be provided by the AP 210. For example, the cellular module 221 may perform at least some of the multimedia control functions.

According to an embodiment, the cellular module 221 may include a Communication Processor (CP). Further, the cellular module 221 may be implemented by, for example, an SoC.

According to an embodiment, the AP 210 or the cellular module 221 (for example, communication processor) may load a command or data received from at least one of a non-volatile memory and other components connected to each of the AP 210 and the cellular module 221 to a volatile memory and process the loaded command or data. Further, the AP 210 or the cellular module 221 may store data received from at least one of other components or generated by at least one of other components in a non-volatile memory.

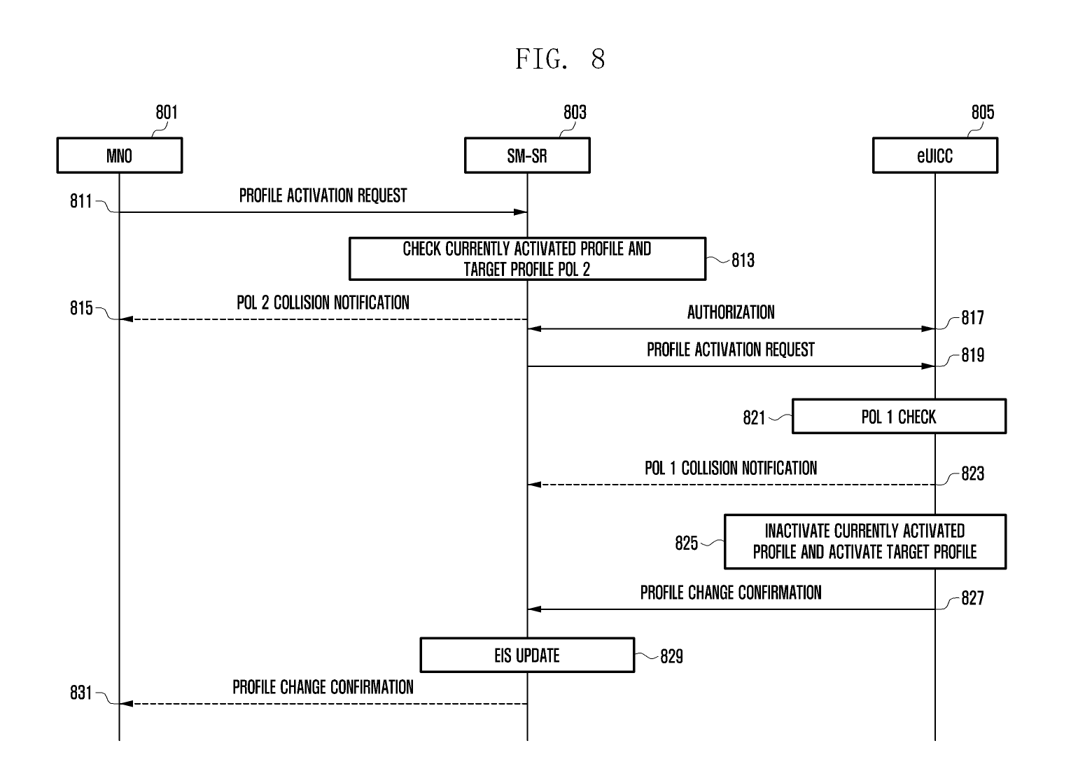

Each of the WiFi module 223, the BT module 225, the GPS module 227, and the NFC module 228 may include, for example, a processor for processing data transmitted/received through the corresponding module. Although the cellular module 221, the WiFi module 223, the BT module 225, the GPS module 227, and the NFC module 228 are illustrated as blocks separate from each other in FIG. 8, at least some (for example, two or more) of the cellular module 221, the WiFi module 223, the BT module 225, the GPS module 227, and the NFC module 228 may be included in one Integrated Chip (IC) or one IC package according to one embodiment. For example, at least some (for example, the communication processor corresponding to the cellular module 221 and the WiFi processor corresponding to the WiFi module 223) of the processors corresponding to the cellular module 221, the WiFi module 223, the BT module 225, the GPS module 227, and the NFC module 228 may be implemented by one SoC.

The RF module 229 transmits/receives data, for example, an RF signal. Although not illustrated, the RF module 229 may include, for example, a transceiver, a Power Amp Module (PAM), a frequency filter, a Low Noise Amplifier (LNA) or the like. Further, the RF module 229 may further include a component for transmitting/receiving electronic waves over a free air space in wireless communication, for example, a conductor, a conducting wire, or the like. Although the cellular module 221, the WiFi module 223, the BT module 225, the GPS module 227, and the NFC module 228 share one RF module 229 in FIG. 2, at least one of the cellular module 221, the WiFi module 223, the BT module 225, the GPS module 227, and the NFC module 228 may transmit/receive an RF signal through a separate RF module according to one embodiment.

The SIM card 224 is a card including a Subscriber Identification Module and may be inserted into a slot formed in a particular portion of the electronic device. The SIM card 224 includes unique identification information (for example, Integrated Circuit Card IDentifier (ICCID)) or subscriber information (for example, International Mobile Subscriber Identity (IMSI).

The memory 230 (for example, memory 130) may include an internal memory 232 or an external memory 234. The internal memory 232 may include, for example, at least one of a volatile memory (for example, a Random Access Memory (RAM), a dynamic RAM (DRAM), a static RAM (SRAM), a synchronous dynamic RAM (SDRAM), and the like), and a non-volatile Memory (for example, a Read Only Memory (ROM), a one time programmable ROM (OTPROM), a programmable ROM (PROM), an erasable and programmable ROM (EPROM), an electrically erasable and programmable ROM (EEPROM), a mask ROM, a flash ROM, a NAND flash memory, an NOR flash memory, and the like).

According to an embodiment, the internal memory 232 may be a Solid State Drive (SSD). The external memory 234 may further include a flash drive, for example, a Compact Flash (CF), a Secure Digital (SD), a Micro Secure Digital (Micro-SD), a Mini Secure Digital (Mini-SD), an extreme Digital (xD), or a memory stick. The external memory 234 may be functionally connected to the electronic device 200 through various interfaces. According to an embodiment, the electronic device 200 may further include a storage device (or storage medium) such as a hard drive.

The sensor module 240 measures a physical quantity or detects an operation state of the electronic device 201, and converts the measured or detected information to an electronic signal. The sensor module 240 may include, for example, at least one of a gesture sensor 240A, a gyro sensor 240B, an atmospheric pressure (barometric) sensor 240C, a magnetic sensor 240D, an acceleration sensor 240E, a grip sensor 240F, a proximity sensor 240G, a color sensor 240H (for example, Red, Green, and Blue (RGB) sensor) 240H, a biometric sensor 240I, a temperature/humidity sensor 240J, an illumination (light) sensor 240K, and a Ultra Violet (UV) sensor 240M. Additionally or alternatively, the sensor module 240 may include, for example, a E-nose sensor, an electromyography (EMG) sensor, an electroencephalogram (EEG) sensor, an electrocardiogram (ECG) sensor, an InfraRed (IR) sensor, an iris sensor, a fingerprint sensor (not illustrated), and the like. The sensor module 240 may further include a control circuit for controlling one or more sensors included in the sensor module 240.

The input device 250 includes a touch panel 252, a (digital) pen sensor 254, a key 256, and an ultrasonic input device 258. For example, the touch panel 252 may recognize a touch input in at least one type of a capacitive type, a resistive type, an infrared type, and an acoustic wave type. The touch panel 252 may further include a control circuit. In the capacitive type, the touch panel 252 can recognize proximity as well as a direct touch. The touch panel 252 may further include a tactile layer. In this event, the touch panel 252 provides a tactile reaction to the user.

The (digital) pen sensor 254 may be implemented, for example, using a method identical or similar to a method of receiving a touch input of the user, or using a separate recognition sheet. The key 256 may include, for example, a physical button, an optical key, or a key pad. The ultrasonic input device 258 is a device which can detect an acoustic wave by a microphone (for example, microphone 288) of the electronic device 200 through an input means generating an ultrasonic signal to identify data and can perform wireless recognition. According to an embodiment, the electronic device 200 receives a user input from an external device (for example, computer or server) connected to the electronic device 200 by using the communication module 220.

The display 260 (for example, display module 160) includes a panel 262, a hologram device 264, and a projector 266. The panel 262 may be, for example, a Liquid Crystal Display (LCD) or an Active Matrix Organic Light Emitting Diode (AM-OLED). The panel 262 may be implemented to be, for example, flexible, transparent, or wearable. The panel 262 may be configured by the touch panel 252 and one module. The hologram device 264 shows a stereoscopic image in the air by using interference of light. The projector 266 projects light on a screen to display an image. For example, the screen may be located inside or outside the electronic device 200. According to an embodiment, the display 260 may further include a control circuit for controlling the panel 262, the hologram device 264, and the projector 266.

The interface 270 includes, for example, a High-Definition Multimedia Interface (HDMI) 272, a Universal Serial Bus (USB) 274, an optical interface 276, and a D-subminiature (D-sub) 278. The interface 270 may be included in, for example, the communication interface 170 illustrated in FIG. 1. Additionally or alternatively, the interface 290 may include, for example, a Mobile High-definition Link (MHL) interface, a Secure Digital (SD) card/Multi-Media Card (MMC), or an Infrared Data Association (IrDA) standard interface.

The audio module 280 bi-directionally converts a sound and an electronic signal. At least some components of the audio module 280 may be included in, for example, the input/output interface 150 illustrated in FIG. 1. The audio module 280 processes sound information input or output through, for example, a speaker 282, a receiver 284, an earphone 286, the microphone 288 or the like.

The camera module 291 is a device which can photograph a still image and a video. According to an embodiment, the camera module 291 may include one or more image sensors (for example, a front sensor or a back sensor), an Image Signal Processor (ISP) (not shown) or a flash (for example, an LED or xenon lamp).

The power managing module 295 manages power of the electronic device 200. Although not illustrated, the power managing module 295 may include, for example, a Power Management Integrated Circuit (PMIC), a charger Integrated Circuit (IC), or a battery or fuel gauge.

The PMIC may be mounted to, for example, an integrated circuit or an SoC semiconductor. A charging method may be divided into wired and wireless methods. The charger IC charges a battery and prevent over voltage or over current from flowing from a charger. According to an embodiment, the charger IC includes a charger IC for at least one of the wired charging method and the wireless charging method. The wireless charging method may include, for example, a magnetic resonance method, a magnetic induction method and an electromagnetic wave method, and additional circuits for wireless charging, for example, circuits such as a coil loop, a resonant circuit, a rectifier or the like may be added.

The battery fuel gauge measures, for example, a remaining quantity of the battery 296, or a voltage, a current, or a temperature during charging. The battery 296 may store or generate electricity and supply power to the electronic device 200 by using the stored or generated electricity. The battery 296 may include a rechargeable battery or a solar battery. The indicator 297 shows particular statuses of the electronic device 200 or a part (for example, AP 210) of the electronic device 200, for example, a booting status, a message status, a charging status and the like. The motor 298 converts an electrical signal to a mechanical vibration.

Although not illustrated, the electronic device 200 may include a processing unit (for example, GPU) for supporting a module TV. The processing unit for supporting the mobile TV may process, for example, media data according to a standard of Digital Multimedia Broadcasting (DMB), Digital Video Broadcasting (DVB), media flow or the like.

Each of the components of the electronic device according to various embodiments of the present disclosure may be implemented by one or more components and the name of the corresponding component may vary depending on a type of the electronic device. The electronic device according to various embodiments of the present disclosure may include at least one of the above described components, a few of the components may be omitted, or additional components may be further included. Also, some of the components of the electronic device according to various embodiments of the present disclosure may be combined to form a single entity, and thus may equivalently execute functions of the corresponding components before being combined.

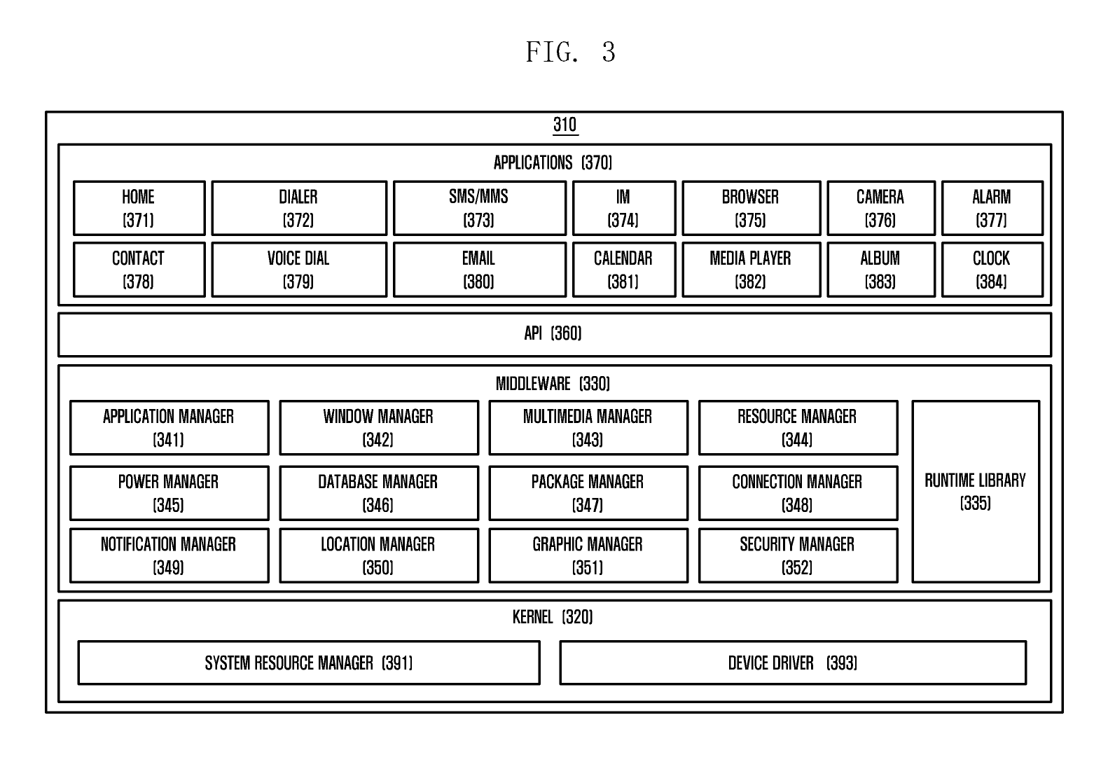

FIG. 3 is a block diagram illustrating an example programming module 310 according to an embodiment. The programming module 310 (for example, programming module 140) may be included (stored) in the electronic device 100 (for example, memory 130) illustrated in FIG. 1. At least some of the programming module 310 may be formed of software, firmware, hardware, or a combination of at least two of software, firmware, and hardware. The programming module 310 may be executed in the hardware (for example, electronic device 200) to include an Operating System (OS) controlling resources related to the electronic device (for example, electronic device 100) or various applications (for example, applications 370) driving on the OS. For example, the OS may be Android, iOS, Windows, Symbian, Tizen, Bada or the like. Referring to FIG. 3, the programming module 310 includes a kernel 320, a middleware 330, an Application Programming Interface (API) 360, and applications 370.

The kernel 320 (for example, kernel 141) includes a system resource manager 321 and a device driver 323. The system resource manager 321 may include, for example, a process manager, a memory manager, and a file system manager. The system resource manager 321 performs a system resource control, allocation, and recall. The device driver 323 may include, for example, a display driver, a camera driver, a Bluetooth driver, a shared memory driver, a USB driver, a keypad driver, a WiFi driver, and an audio driver. Further, according to an embodiment, the device driver 323 may include an Inter-Process Communication (IPC) driver. The middleware 330 includes a plurality of modules prepared in advance to provide a function required in common by the applications 370. Further, the middleware 330 provides a function through the API 360 to allow the application 370 to efficiently use limited system resources within the electronic device. For example, as illustrated in FIG. 3, the middleware 300 (for example, middleware 143) includes at least one of a runtime library 335, an application manager 341, a window manager 342, a multimedia manager 343, a resource manager 344, a power manager 345, a database manager 346, a package manager 347, a connection manager 348, a notification manager 349, a location manager 350, a graphic manager 351, and a security manager 352. The runtime library 335 includes, for example, a library module used by a complier to add a new function through a programming language while the application 370 is executed. According to an embodiment, the runtime library 335 executes input and output, management of a memory, a function associated with an arithmetic function and the like. The application manager 341 manages, for example, a life cycle of at least one of the applications 370. The window manager 342 manages GUI resources used on the screen. The multimedia manager 343 detects a format required for reproducing various media files and performs an encoding or a decoding of a media file by using a codec suitable for the corresponding format. The resource manager 344 manages resources such as a source code, a memory, or a storage space of at least one of the applications 370.

The power manager 345 operates together with a Basic Input/Output System (BIOS) to manage a battery or power and provides power information required for the operation. The database manager 346 manages generation, search, and change of a database to be used by at least one of the applications 370. The package manager 347 manages an installation or an update of an application distributed in a form of a package file.

The connection manager 348 manages, for example, a wireless connection such as WiFi or Bluetooth. The notification manager 349 displays or notifies a user of an event such as an arrival message, an appointment, a proximity alarm or the like, in a manner that does not disturb the user. The location manager 350 manages location information of the electronic device. The graphic manager 351 manages a graphic effect provided to the user or a user interface related to the graphic effect. The security manager 352 provides a general security function required for a system security or a user authentication. According to an embodiment, when the electronic device (for example, electronic device 100 or 200) has a call function, the middleware 330 may further include a telephony manager for managing a voice of the electronic device or a video call function. The middleware 330 may generate a new middleware module through a combination of various functions of the aforementioned internal component modules and use the generated new middleware module. The middleware 330 may provide a module specified for each type of operating system to provide a differentiated function. Further, the middleware 330 may dynamically delete some of the conventional components or add new components. Accordingly, some of the components described in the embodiment of the present disclosure may be omitted, replaced with other components having different names but performing similar functions, or other components may be further included.

The API 360 (for example, API 145) is a set of API programming functions, and may be provided with a different configuration according to an operating system. For example, in Android or iOS, a single API set may be provided for each platform. In Tizen, two or more API sets may be provided. The applications 370, which may include an application similar to the application 134, may include, for example, a preloaded application and/or a third party application. The applications 370 may include a home application 371 a dialer application 372, a Short Messaging Service (SMS)/Multlimedia Messaging Service (MMS) application 373, an Instant Messaging (IM) application 374, a browser application 375, a camera application 376, an alarm application 377, a contact application 378, a voice dial application 379, an email application 380, a calendar application 381, a media player application 382, an album application 383, and a clock application 384. However, the present embodiment is not limited thereto, and the applications 370 may include any other similar and/or suitable application. At least a part of the programming module 310 can be implemented by commands stored in computer-readable storage media. When the commands are executed by at least one processor, e.g. the AP 210, at least one processor can perform functions corresponding to the commands. The computer-readable storage media may be, for example, the memory 230. At least a part of the programming module 310 can be implemented, e.g. executed, by, for example, the AP 210. At least a part of the programming module 310 may include, for example, a module, a program, a routine, a set of instructions and/or a process for performing at least one function.

The titles of the aforementioned elements of the programming module, e.g. the programming module 300, according to the present disclosure may vary depending on the type of the OS. The programming module according to the present disclosure may include at least one of the aforementioned elements and/or may further include other additional elements, and/or some of the aforementioned elements may be omitted. The operations performed by a programming module and/or other elements according to the present disclosure may be processed through a sequential, parallel, repetitive, and/or heuristic method, and some of the operations may be omitted and/or other operations may be added.

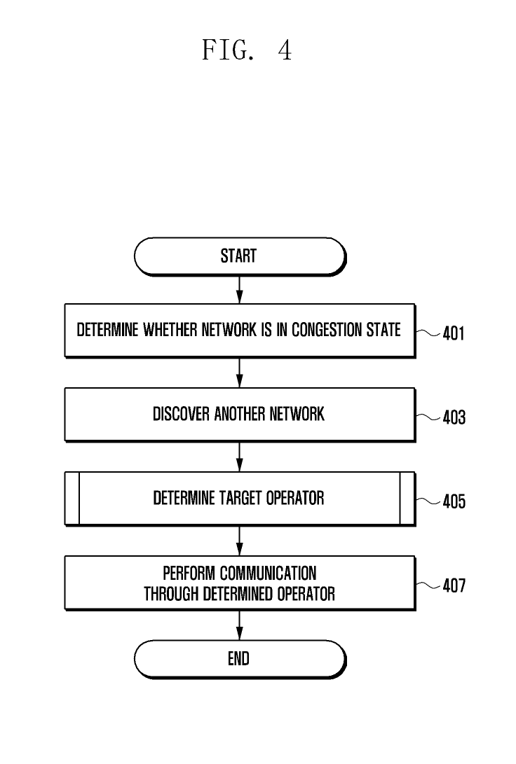

FIG. 4 is a flowchart illustrating an example method for operating communication of an electronic device 100 according to various embodiments of the present disclosure.

At operation 401, the electronic device 100 may determine whether a network is in a congestion state through the network congestion determination module 180.

In an embodiment, if a message or a signal regarding network congestion is received from the network 162 through the communication interface 170, the electronic device 100 may determine that the network 162 is in the congestion state.

The message or the signal regarding the network congestion may be a message or a signal that is defined in User Plane Congestion (UPCON) that is defined in the mobile communication standard document 3GPP TS 23.705.

In various embodiments, even if the message or the signal regarding the network congestion is not received, the electronic device 100 may determine whether the network is in the congestion state. The electronic device 100 may estimate the network congestion rate based on monitoring of the network 162. The electronic device 100 may determine that the network is in the congestion state based on the estimated network congestion rate. For example, in order to establish communication, the electronic device 100 may request resource allocation from the network 162. If the network 162 is in the congestion state, the network 162 may not respond to the resource allocation request of the electronic device 100, but may reject the request to improve the congestion rate.

The electronic device 100 may monitor the resource allocation rejection rate of the network 162, and if the resource allocation rejection rate becomes higher than a predetermined rate, the electronic device 100 may determine that the network 162 is in the congestion state through the network congestion determination module 180.

At operation 403, the electronic device 100 may discover other networks.

If it is determined that the network is in the congestion state, at operation 403, the electronic device 100 may discover other networks to perform communication through the other networks.

In an embodiment, when discovering other networks, the electronic device 100 may retrieve other networks around the electronic device 100. The electronic device 100 may retrieve other networks around the electronic device 100 using information regarding the other networks (e.g., PLMN information or PLMN load information) that is transferred from the network 162. The electronic device 100 may preferentially retrieve a specific Public Land Mobile Network (PLMN, operator network identification number) using the information regarding other networks that is transferred from the network 162. For example, specific PLMN information may be included in the information regarding other networks that is transferred from the network 162.

The electronic device 100 includes the UICC module 224, and may include a detachable Universal Integrated Circuit (UICC) or eUICC as a card that can be used as a network access authorization module.

In an embodiment, in the case where the UICC module 224 of the electronic device 100 includes the eUICC, profiles of at least one network operator (e.g., MNO or PLMN) may be installed in the eUICC.

The electronic device 100 may preferentially retrieve the installed profiles of other network operators excluding the profile of the network that is currently in the congestion state. The electronic device 100 may select a network operator that is determined not to be in the congestion state, and may perform communication through the selected operator.

In various embodiments, if it is determined that the networks having pre-installed profiles are also in the congestion state as the result of retrieving the pre-installed profiles of the network operators, the electronic device 100 may download, install, and retrieve the profiles of the operators of which the profiles have not been installed through the communication interface 170.

In an embodiment, in the case where the electronic device 100 includes a detachable UICC, for example, in the case of a dual SIM, the electronic device 100 may include at least one detachable UICC.

The electronic device 100 may retrieve other detachable UICCs excluding the detachable UICC that is currently in the congestion state. The electronic device 100 may select a network operator that is determined not to be in the congestion state, and may perform communication through the selected operator.

Like operation 403, the electronic device 100 may confirm whether other networks are in the congestion state in the process of discovering the other networks. For example, at least one network may broadcast the congestion situation, and the electronic device 100 may confirm whether the network is in the congestion state in the process of network discovery. A case where a network broadcasts a congestion situation is disclosed in the mobile communication standard document TS 23.705.

The electronic device 100 may report the results of retrieving other networks to the network 162. For example, the electronic device 100 may report at least one of load information of other networks, channel quality, Received Signal Strength Indication (RSSI), Signal to Noise Ratio (SNR), Signal to Interference-plus-Noise Ratio (SINR), and profile list installed in an embedded UICC to the network 162 as the results of retrieving other networks.

At operation 405, the electronic device 100 may determine another network operator that is not in the congestion state as a target operator. The electronic device 100 may select a network that is not in the congestion state among the other retrieved networks, and may determine an operator that corresponds to the selected network as the target operator.

At operation 407, the electronic device 100 may perform communication through the determined target operator.

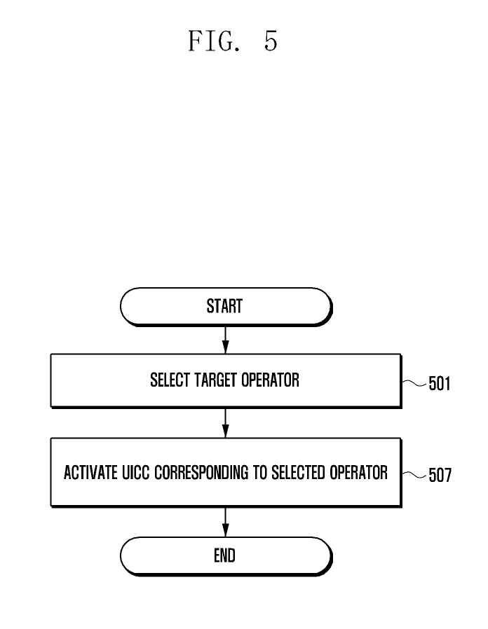

FIG. 5 is a flowchart illustrating an example method for determining a target operator in the case where an electronic device 100 according to various embodiments of the present disclosure includes a UICC that is detachably attached to a UICC module 224.

At operation 403, the electronic device 100 may discover other networks. If the electronic device 100 discovers other networks, at operation 501, the electronic device 100 may select an operator that provides a network that is less congested as a target operator. In order to perform communication through the target operator that provides a network that is less congested, the electronic device 100 may retrieve other detachable UICCs excluding the detachable UICC that includes the network that is less congested.

At operation 507, the electronic device 100 may activate the detachable UICC that corresponds to the selected target operator. The electronic device 100 may activate the detachable UICC that corresponds to the target operator, and may inactivate other detachable UICCs.

The electronic device 100 may activate the detachable UICC that corresponds to the target operator, and may be connected to the network through the target operator to perform communication.

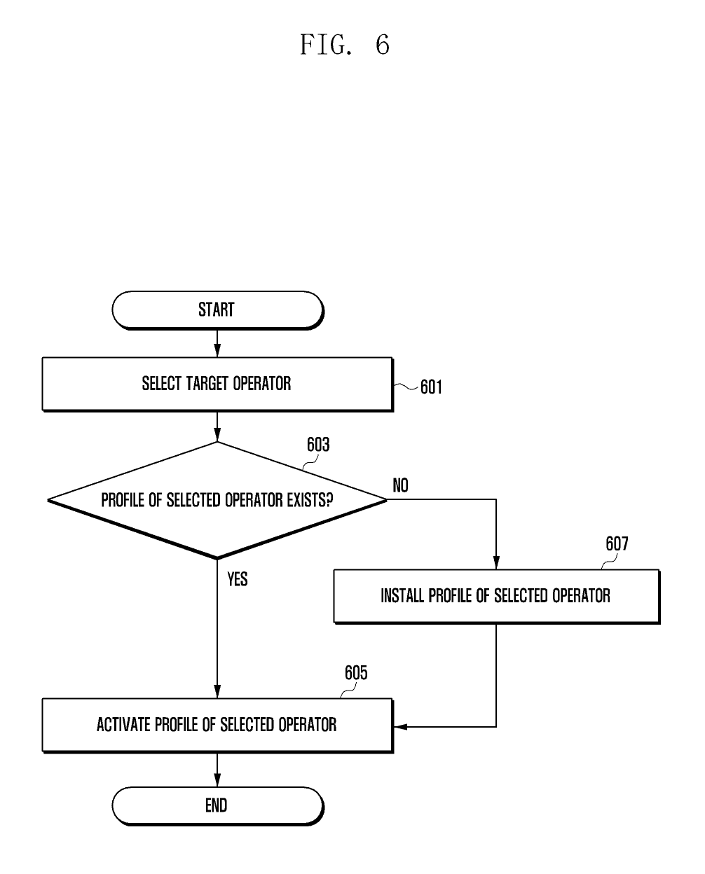

FIG. 6 is a flowchart illustrating an example method for determining a target operator in the case where an electronic device 100 according to various embodiments of the present disclosure includes a UICC that is embedded in a UICC module 224.

At operation 403, the electronic device 100 may discover other networks. If the electronic device 100 discovers other networks, at operation 601, the electronic device 100 may select an operator that provides a network that is less congested as a target operator.

In order to perform communication through the target operator that provides a network that is less congested, the electronic device 100 may be connected to the network through the target operator in place of the operator that provides the network that is currently in the congested state.

At operation 603, the electronic device 100 may determine whether there is a profile of the selected target operator. At operation 603, the electronic device 100 may determine whether the profile of the selected target operator is stored in the embedded UICC.

If the profile of the selected target operator is stored in the embedded UICC, the electronic device 100 may activate the profile of the selected target operator.

If the profile of the selected target operator is activated, the electronic device 100 may be connected to the network through the selected target operator.

If the profile of the selected target operator is not stored in the embedded UICC, at operation 607, the electronic device 100 may install the profile of the selected target operator.

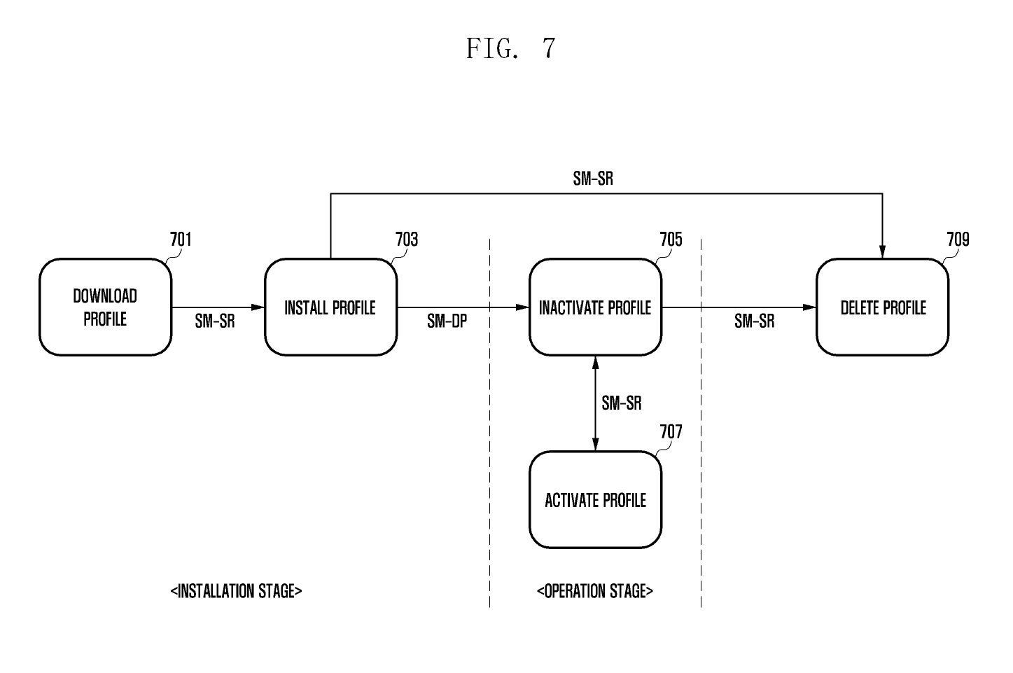

FIG. 7 is a diagram illustrating an example state machine regarding profile installation and activation in an electronic device 100 including an embedded UICC according to various embodiments of the present disclosure.

At operation 701, the electronic device 100 may download the profile of the selected target operator through the communication interface 170.

A Subscription Manager (SM) may be an entity that performs overall management of the embedded UICC, such as issuance of an important profile (that may be called an operator credential, MNO credential, profile, uEICC profile, or profile package) to the embedded UICC, and performing of a subscription changing process, or a device that performs the function/role of the entity.

The SM may perform SM-Data Preparation (DP) that generates operator (MNO) information and SM-Secure Routing (SR) that performs direct transport of the operator information.

The SM, SM-DP, and SM-SR may be implemented by a server to transfer commands of the electronic device 100.

At operation 703, the electronic device 100 may install the downloaded profile of the target operator in accordance with the determination of the SM-SR.

At operation 705, the electronic device 100 may inactivate the installed profile of the target operator in accordance with the determination of the SM-DP.

At operation 707, the electronic device 100 may activate the inactivated profile of the target operator in accordance with the determination of the SM-SR.

The operations 701 and 703 may be profile installation stages, and the operations 705 and 707 may be profile operation stages.

At operation 709, the electronic device 100 may delete the inactivated profile of the target operator in accordance with the determination of the SM-SR.

In another embodiment, at operation 709, the electronic device 100 may delete the installed profile of the target operator in accordance with the determination of the SM-SR.

FIG. 8 is a flowchart illustrating an example profile activation of a target operator in an electronic device 100 including an embedded UICC according to various embodiments of the present disclosure.

At operation 811, an operator (MNO) 801 may request the SM-SR to activate the profile of the target operator.

At operation 813, the SM-SR 803 confirms POL 2 of the currently activated profile and the profile of the target operator in response to the request for the operator (MNO) 801 to activate the profile of the target operator.

POL 1 relates to SM policy that corresponds to the regulations related to activation and inactivation of the profile and deletion permission and automatic deletion of the profile on the embedded UICC.

POL 2 relates to SM policy that corresponds to the regulations related to activation and inactivation of the profile and deletion permission and automatic deletion of the profile on the SM-SR.

In the case where the currently activated profile collides with the profile of the target operator, the SM-SR 803 may notify the operator (MNO) 801 of POL 2 collision.

In the case where the currently activated profile does not collide with the profile of the target operator, at operation 817, the SM-SR 803 and the embedded UICC (eUICC) 805 of the electronic device 100 may perform authorization of the profile of the target operator.

At operation 819, the SM-SR 803 may request activation of the profile of the target operator from the embedded UICC (eUICC) 805.

At operation 821, the embedded UICC (eUICC) 805 may confirm POL 1. If collision with the profile of the target operator occurs as the result of POL 1 confirmation, at operation 823, the embedded UICC (eUICC) 805 may transfer a notification of the POL 1 collision to the SM-SR 803.

If collision with the profile of the target operator does not occur as the result of POL 1 confirmation, at operation 825, the embedded UICC (eUICC) 805 may inactivate the currently activated profile and may activate the profile of the target operator.

At operation 827, the embedded UICC (eUICC) 805 may transfer a confirmation message for the change of the profile of the target operator to the SM-SR 803.

At operation 829, the SM-SR 803 may update eUICC Information Set (EIS) of the embedded UICC (eUICC) 805. At operation 829, the SM-SR may update information on installation and activation of the profile of the target operator and inactivation of the previous profile as the EIS.

At operation 831, the SM-SR 803 may transfer the confirmation message for the profile change to the operator (MNO) 801.

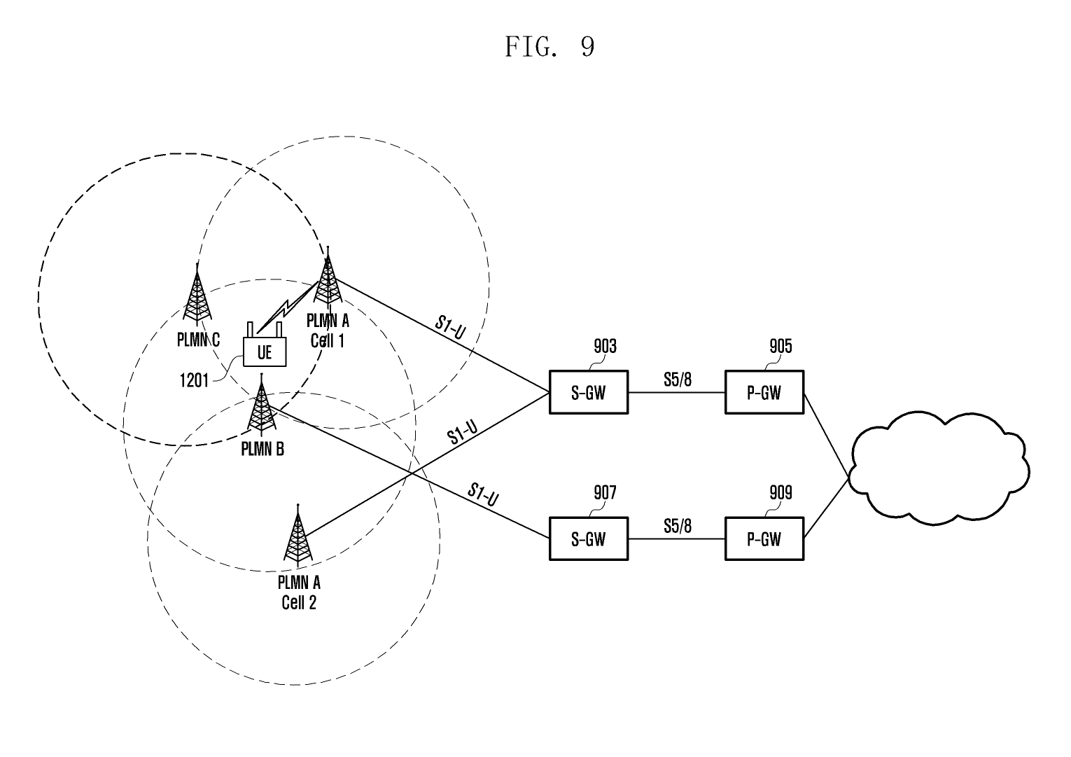

FIG. 9 is a diagram illustrating an example method for operating communication of an electronic device 901 according to various embodiments of the present disclosure.

For example, if a network congestion situation occurs while an electronic device 901 performs communication through a S-GW 903 and a P-GW 905 in a network of an operator (PLMN) A, the electronic device 901 may change the target operator to an operator (PLMN) B, and may perform communication through a S-GW 907 and a P-GW 909 in a network of the operator (PLMN) B.

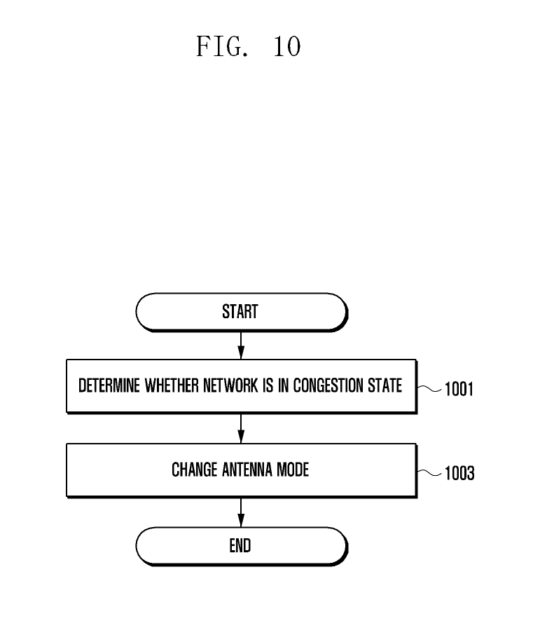

FIG. 10 is a flowchart illustrating an example method for operating communication of an electronic device 100 according to various embodiments of the present disclosure.

At operation 1001, the electronic device 100 may determine whether a network is in a congestion state through the network congestion determination module 180.

In an embodiment, if a message or a signal regarding network congestion is received from the network 162 through the communication interface 170, the electronic device 100 may determine that the network 162 is in the congestion state.

The message or the signal regarding the network congestion may be a message or a signal that is defined in User Plane Congestion (UPCON) that is defined in the mobile communication standard document 3GPP TS 23.705.

In various embodiments, even if the message or the signal regarding the network congestion is not received, the electronic device 100 may determine whether the network is in the congestion state. The electronic device 100 may estimate the network congestion rate based on monitoring of the network 162. The electronic device 100 may determine that the network is in the congestion state based on the estimated network congestion rate. For example, in order to establish communication, the electronic device 100 may request resource allocation from the network 162. If the network 162 is in the congestion state, the network 162 may not respond to the resource allocation request of the electronic device 100, but may reject the request to improve the congestion rate.

The electronic device 100 may monitor the resource allocation rejection rate of the network 162, and if the resource allocation rejection rate becomes higher than a predetermined rate, the electronic device 100 may determine that the network 162 is in the congestion state through the network congestion determination module 180.

If it is determined that the network is in the congestion state, at operation 1003, the electronic device 100 may change an antenna mode. In various embodiments, the electronic device 100 may make antennas that operate in a multiplex mode using a plurality of antennas operate in a single antenna mode. This operation is to use wireless resources of a Uu interface that is not in use.

In various embodiments, the electronic device may virtualize the antennas through biding of the plurality of antennas. For example, if it is determined that the network is in the congestion state, the electronic device 100 that operates with four antennas may virtualize the antennas through biding of the antennas two by two so as to operate with two antennas.

If the electronic device 100 changes the antenna mode as at operation 1003, the wireless resources of the Uu interface that is not in use can be utilized, and battery resources can be used more efficiently.

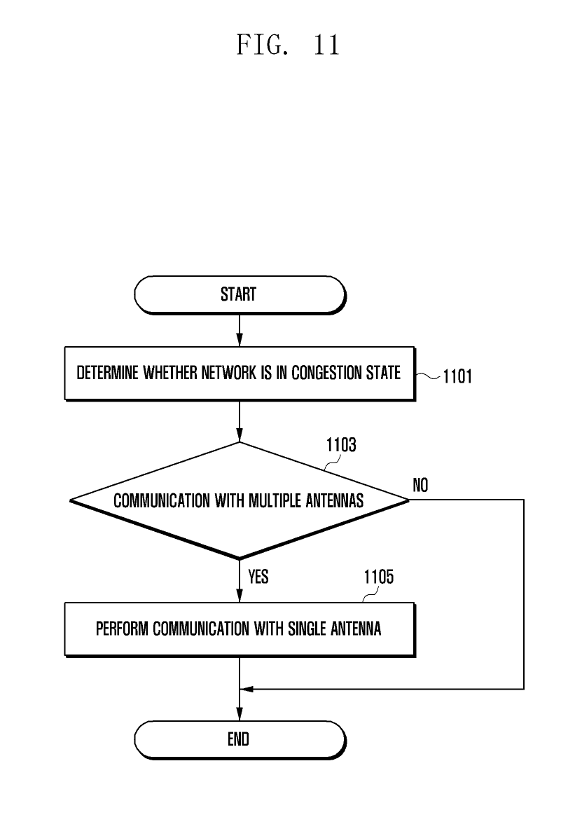

FIG. 11 is a flowchart illustrating an example method for operating communication of an electronic device 100 according to various embodiments of the present disclosure.

At operation 1101, the electronic device 100 may determine whether a network is in a congestion state through the network congestion determination module 180.

At operation 1103, the electronic device 100 may determine whether to operate in a multi-antenna mode in which it performs communication using a plurality of antennas.

In the case where the electronic device 100 operates in a multi-antenna mode, at operation 1105, the electronic device 100 may operate with a single antenna. If the electronic device 100 does not operation in a multi-antenna mode, it may determine that it operates with a single antenna, and thus may not change the antenna mode.

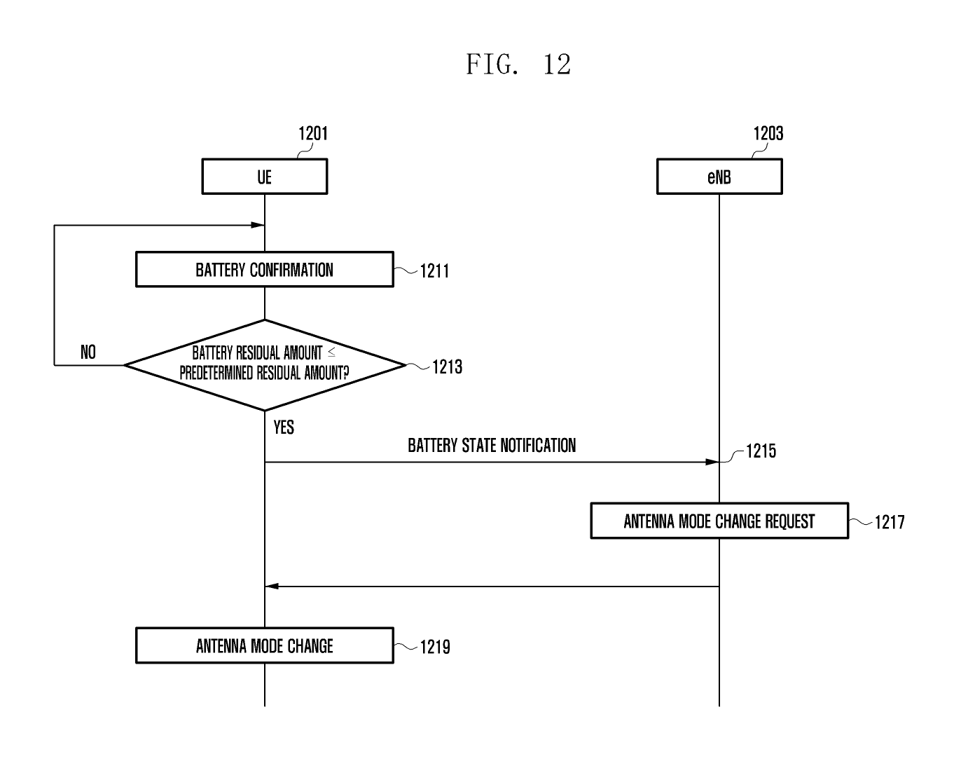

FIG. 12 is a flowchart illustrating an example method for operating communication of an electronic device 100 according to various embodiments of the present disclosure.

At operation 1211, an electronic device (e.g., UE) 1201 may confirm a battery state such as a battery residual amount.

At operation 1213, the electronic device (UE) 1201 may determine whether the battery residual amount is equal to or smaller than a predetermined residual amount.

If it is determined that the battery residual amount is equal to or smaller than the predetermined residual amount, the electronic device (UE) 1201 may notify a network (e.g., evolved Node B (eNB)) 1203 of the battery state. If a notification on the battery state is received from the electronic device (UE) 1201, at operation 1117, the electronic device (UE) 1201 may be requested to change the antenna mode.

At operation 1219, the electronic device (UE) 1201 may change the antenna mode if it receives an antenna mode change request from the network (e.g., evolved Node B (eNB)) 1203.

The electronic device (UE) 1201 may change the antenna mode as follows. If the electronic device (UE) 1201 that operates in a multi-antenna mode receives the antenna mode change request from the network (e.g., evolved Node B (eNB)) 1203, it may operate with a single antenna. In various embodiments, if the electronic device (UE) 1201 receives the antenna mode change request from the network (e.g., evolved Node B (eNB)) 1203, the electronic device may virtualize the antennas to operate the virtualized antennas. For example, if the electronic device (UE) 1201 that operates with four antennas may virtualize the antennas through biding of the antennas two by two so as to operate with two antennas.

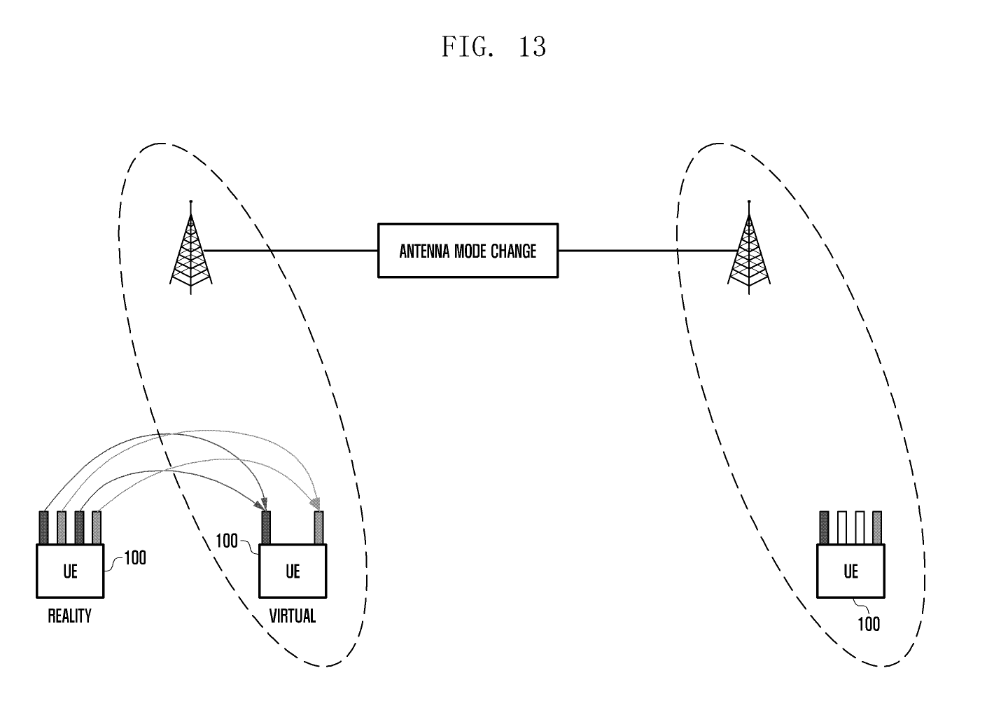

FIG. 13 is a diagram illustrating an example antenna mode change of an electronic device 100 according to various embodiments of the present disclosure.

If the antenna mode change request is received or if it is determined that the network is in the congestion state, the electronic device 100 may virtualize the antennas through biding of the plurality of antennas. For example, if the antenna mode change request is received or if it is determined that the network is in the congestion state, the electronic device 100 may virtualize the antennas through biding of the antennas two by two so as to operate with two antennas.

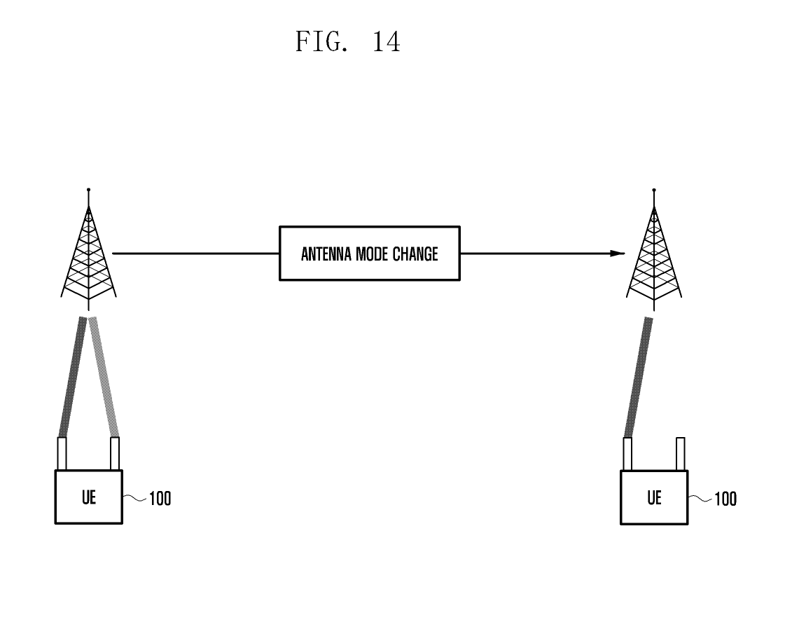

FIG. 14 is a diagram illustrating an example antenna mode change of an electronic device 100 according to various embodiments of the present disclosure.

If the antenna mode change request is received or if it is determined that the network is in a congestion state in a state where the electronic device 100 operates in a multi-antenna mode, the electronic device 100 may operate with a single antenna.

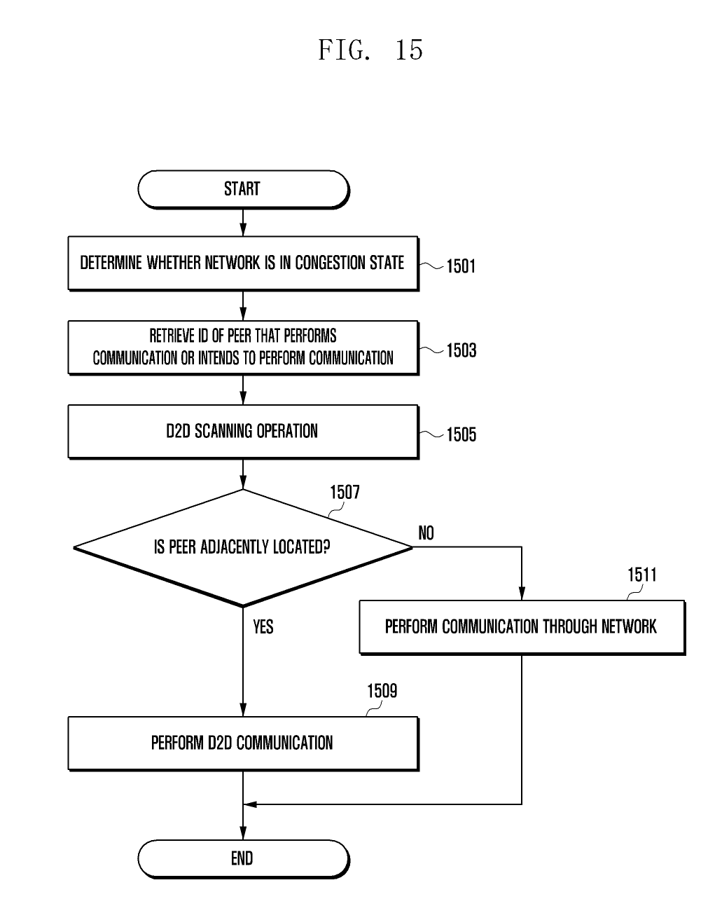

FIG. 15 is a flowchart illustrating an example method for operating communication of an electronic device 100 according to various embodiments of the present disclosure.

At operation 1501, the electronic device 100 may determine whether a network is in a congestion state through the network congestion determination module 180.

In an embodiment, if a message or a signal regarding network congestion is received from the network 162 through the communication interface 170, the electronic device 100 may determine that the network 162 is in the congestion state.

The message or the signal regarding the network congestion may be a message or a signal that is defined in User Plane Congestion (UPCON) that is defined in the mobile communication standard document 3GPP TS 23.705.

In various embodiments, even if the message or the signal regarding the network congestion is not received, the electronic device 100 may determine whether the network is in the congestion state. The electronic device 100 may estimate the network congestion rate based on monitoring of the network 162. The electronic device 100 may determine that the network is in the congestion state based on the estimated network congestion rate. For example, in order to establish communication, the electronic device 100 may request resource allocation from the network 162. If the network 162 is in the congestion state, the network 162 may not respond to the resource allocation request of the electronic device 100, but may reject the request to improve the congestion rate.

The electronic device 100 may monitor the resource allocation rejection rate of the network 162, and if the resource allocation rejection rate becomes higher than a predetermined rate, the electronic device 100 may determine that the network 162 is in the congestion state through the network congestion determination module 180.

The electronic device 100 may retrieve an ID of a peer (peer ID) that performs communication through the network or that intends to perform Device to Device (D2D) communication.

In an embodiment, the peer ID may be obtained periodically or through a specific event (e.g., contact address registration or SNS friend registration), and may be provided to various kinds of applications (e.g., video call, SNS, or messenger application) of the electronic device 100.

The peer ID may be one of an EPC ProSe subscriber ID, application layer user ID, application ID, Wi-Fi MAC address, BT MAC address, ProSe UE ID, ProSe Layer-2 Group ID, ProSe Application ID, OS Application ID, and ProSe application code. The peer ID may be defined in the mobile communication standard document TS 23.303 chapter 4.6.

The peer ID identification process may be performed independently or in association with the electronic device 100 and constituent elements (e.g., ProSe function, ProSe application server, application server Mobility Management Entity (MME), Home Subscriber Server (HSS), and SUPL location platform) of the network (e.g., LTE, 5G communication, and WCDMA).

When the electronic device 100 performs retrieval of the peer ID and Device to Device (D2D) scanning in the communication operation process, it may perform an operation according to the mobile communication standard document TS 23.303 regarding LTE direct D2D communication. The Proximity Service (ProSe, mobile communication standard document TS 23.303) relates to a method for performing D2D communication with users who use the LTE network.

At operation 1505, the electronic device 100 may perform D2D scanning. The electronic device 100 may communicate with a peer (e.g., another electronic device 102 or 104) through at least one of ProSe discovery through the retrieved peer ID, Wi-Fi (WLAN) scan, Wi-Fi (WLAN) direct scan, and Bluetooth (BT) scan. The Wi-Fi (WLAN) and the Wi-Fi (WLAN) direct may commonly perform communication through the WiFi module 223, but may differ from each other on the points that the Wi-Fi (WLAN) performs D2D communication using an Access Point (AP) and the Wi-Fi (WLAN) direct performs D2D communication without the AP.

At operation 1507, the electronic device 100 may determine whether a peer (e.g., another electronic device 102 or 104) having the retrieved peer ID is adjacently located.

If a peer (e.g., another electronic device 102 or 104) having the retrieved peer ID is adjacently located, at operation 1509, the electronic device 100 may perform D2D communication with the peer (e.g., another electronic device 102 or 104).

If a peer (e.g., another electronic device 102 or 104) having the retrieved peer ID is not adjacently located, at operation 1511, the electronic device 100 may maintain the communication with the peer (e.g., another electronic device 102 or 104) through the network.

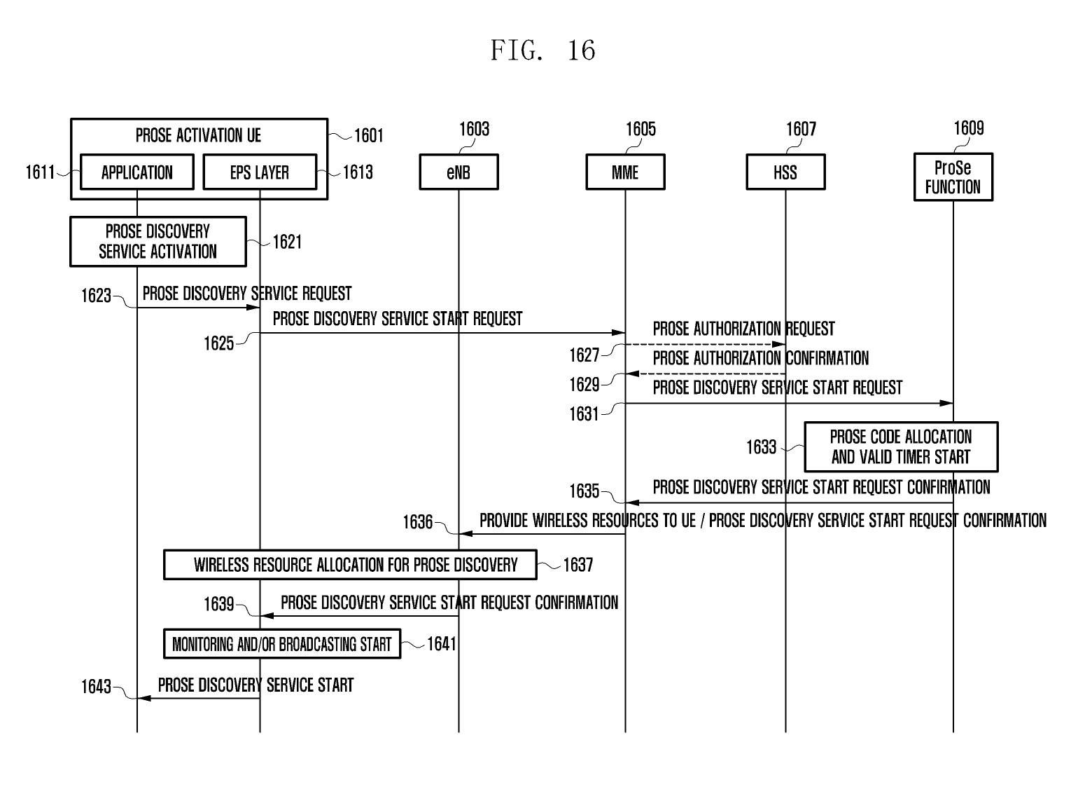

FIG. 16 is a flowchart illustrating an example D2D scanning method of an electronic device 100 according to various embodiments of the present disclosure.

FIG. 16 is a flowchart illustrating an example method for starting a ProSe discovery service in a D2D scanning method of the electronic device 100.

User Equipment (UE) 1601, of which the ProSe is activated, for example, electronic device 100, may have a ProSe application 1611 installed therein. The User Equipment (UE) 1601 of which the ProSe is activated may have an Evolved Packet System (EPS) layer installed therein. The EPS layer means a lower communication (e.g., LTE or 5G communication) layer, and may be configured in the communication module (e.g., modem) 170.

At operation 1621, the ProSe application 1611 of the User Equipment (UE) 1601 may activate a ProSe discovery service.

If the ProSe discovery service is activated in the ProSe application 1611, at operation 1623, the User Equipment (UE) 1601 may include an operating system application ID (OSApp_ID), and the ProSe application 1611 may request the ProSe discovery service from the EPS layer in the User Equipment (UE) 1601.

At operation 1625, the User Equipment (UE) 1601 may include an operating system application ID (OSApp_ID), and the EPS layer may request the ProSe discovery service from the MME 1605.

At operations 1627 and 1629, for communication between the MME 1605 and the HSS 1607, it may be confirmed whether ProSe authorization of the User Equipment (UE) 1601 is completed.

At operation 1627, the MME 1605 may request the ProSe authorization of the User Equipment (UE) 1601 from the HSS 1607.

At operation 1629, the HSS 1607 may confirm the ProSe authorization of the User Equipment (UE) 1601 from the MME 1605.

If the ProSe authorization of the User Equipment (UE) 1601 is completed, at operation 1631, the MME 1605 may request the ProSe discovery service from a ProSe function 1609 through inclusion of the operating system application ID (OSApp_ID) and IMSI.

At operation 1633, the ProSe function 1609 may map the operating system application ID (OSApp_ID) on the application (App_ID), allocate a ProSe code, and start a valid timer.

At operation 1635, the ProSe function 1609 may transfer a ProSe discovery service start request confirmation message to the MME 1605. At operation 1636, the MME 1605 may make the evolved Node B (eNB) 1603 provide wireless resources to the User Equipment (UE) 1601 and may transfer the ProSe discovery service start request confirmation message.

If the ProSe discovery service start request confirmation message is transferred from the MME 1605, at operation 1637, the evolved Node B (eNB) 1603 may allocate the wireless resources for the ProSe discovery to the User Equipment (UE) 1601.

At operation 1639, the evolved Node B (eNB) 1603 may transfer the ProSe discovery service start request confirmation message to the User Equipment (UE) 1601.

If the wireless resources are allocated and the ProSe discovery service start request confirmation message is transferred from the evolved Node B (eNB) 1603, at operation 1641, the EPS layer 1613 of the User Equipment (UE) 1601 may start wireless resource monitoring and/or broadcasting.

At operation 1643, the EPS layer 1613 may request the ProSe application 1611 to start the ProSe discovery service.

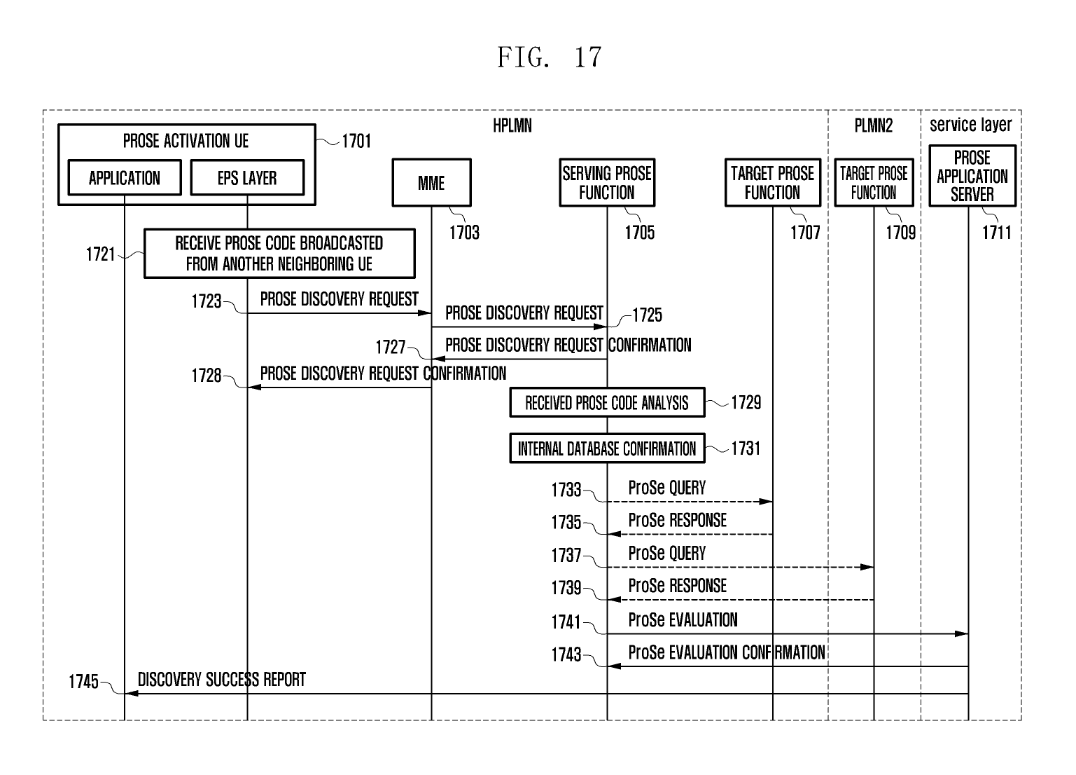

FIG. 17 is a flowchart explaining a D2D scanning method of an electronic device 100 according to various embodiments of the present disclosure.

FIG. 17 is a flowchart illustrating an example ProSe discovery method in a D2D scanning method of the electronic device 100.

At operation 1721, the EPS layer of the User Equipment (UE) 1701, of which the ProSe is activated, may receive a ProSe code that is broadcasted from another User Equipment (e.g., another electronic device 102 or 104).

At operation 1723, the EPS layer of the User Equipment (UE) 1701 may request ProSe discovery from the MME 1703 together with the ProSe code.

At operation 1725, the MME 1703 may request the ProSe discovery from a serving ProSe function 1705. If the ProSe discovery is requested from the MME 1703, at operation 1727, the serving ProSe function 1705 may transfer a ProSe discovery request confirmation message to the MME 1703. If the ProSe discovery request confirmation message is transferred, at operation 1728, the MME 1703 may transfer the ProSe discovery request confirmation message to the EPS layer of the User Equipment (UE) 1701. If the ProSe code is received, at operation 1729, the serving ProSe function 1705 may analyze the received ProSe code. Through analysis of the received ProSe code, at operation 1731, the serving ProSe function 1705 may confirm an internal database.

At operation 1733, the serving ProSe function 1705 may perform ProSe query with respect to a target ProSe function (e.g., device that intends to perform D2D communication) 1707. At operation 1735, the target ProSe function 1707 may respond to the query of the serving ProSe function 1705.

At operation 1737, the serving ProSe function 1705 may perform ProSe query with respect to a target ProSe function (e.g., another operator that intends to perform D2D communication) 1709. At operation 1739, the target ProSe function 1709 may respond to the query of the serving ProSe function 1705. At operation 1741, the serving ProSe function 1705 may request ProSe evaluation from a ProSe application server 1711. At operation 1743, the ProSe application server 1711 may respond to the evaluation request of the serving ProSe function 1705.

The ProSe application server 1711 may report discovery success to the ProSe application of the User Equipment (UE) 1701.

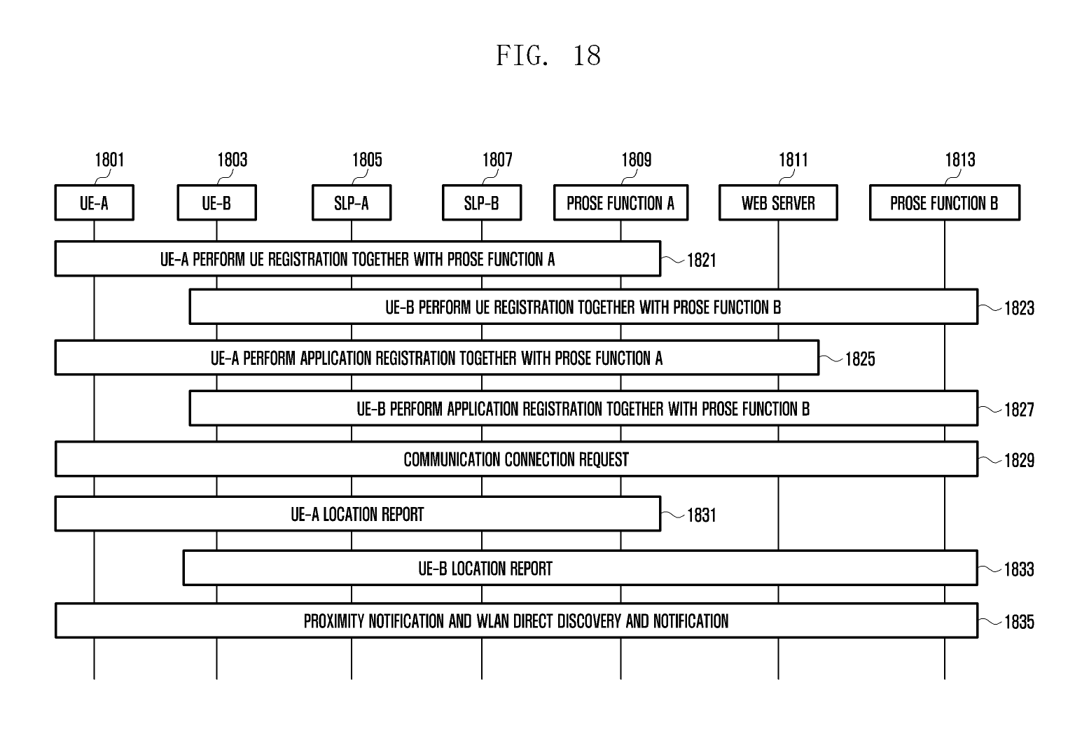

FIG. 18 is a flowchart illustrating an example D2D scanning method of an electronic device 100 according to various embodiments of the present disclosure.

FIG. 18 is a flowchart illustrating an example method for EPC level ProSe discovery (e.g., WLAN direct discovery) in a D2D scanning method of the electronic device 100. The EPC level ProSe discovery is defined in the mobile communication document TS 23.303 chapter 5.5.

At operation 1821, User Equipment A (UE-A) 1801 performs user equipment registration along with ProSe function A 1809.

At operation 1823, User Equipment B (UE-B) 1803 performs user equipment registration along with ProSe function B 1813.

At operation 1825, the User Equipment A (UE-A) 1801 performs user equipment registration along with the ProSe function A 1809.

At operation 1827, the User Equipment B (UE-B) 1803 performs user equipment registration along with the ProSe function B 1813.

At operation 1829, the User Equipment A (UE-A) and the User Equipment B (UE-B) may perform communication connection request. In various embodiments, the communication connection request at operation 1829 may be a proximity request that is defined in the mobile communication document TS 23.303 chapter 5.5.

At operation 1831, the User Equipment A (UE-A) 1801 may report the location.

At operation 1833, the User Equipment B (UE-B) 1803 may report the location.

At operation 1835, the User Equipment A (UE-A) 1801 and the User Equipment B (UE-B) 1803 may perform proximity notification and WLAN direct discovery and notification.

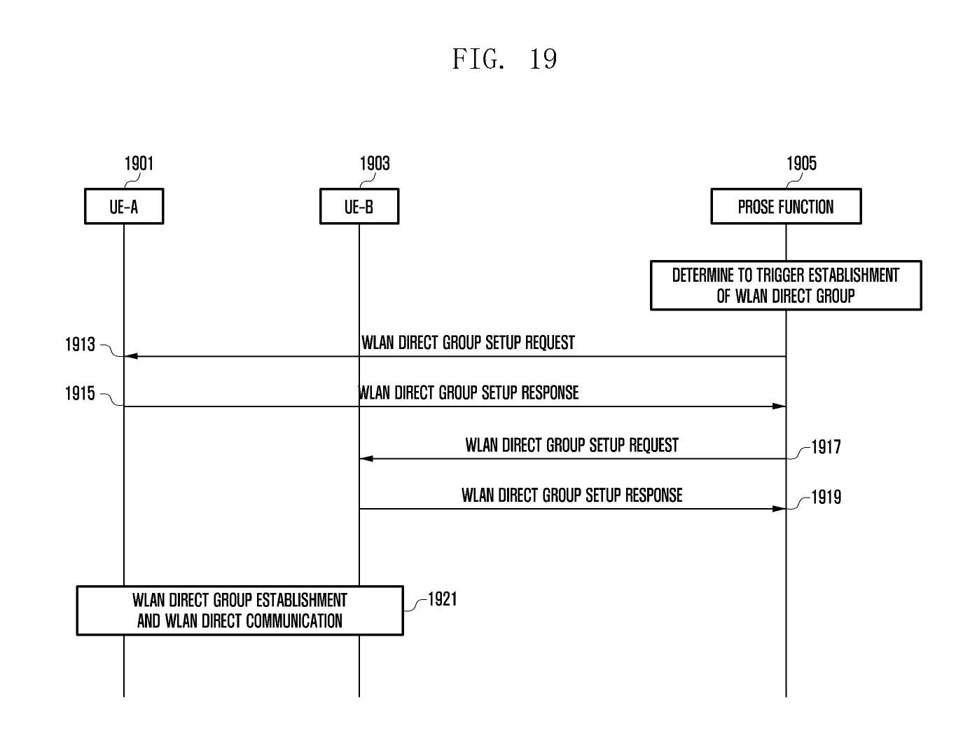

FIG. 19 is a flowchart illustrating an example D2D scanning method of an electronic device 100 according to various embodiments of the present disclosure.

FIG. 19 is a flowchart illustrating method for EPC level ProSe discovery (e.g., WLAN direct discovery) in a D2D scanning method of the electronic device 100. The EPC level ProSe discovery is defined in the mobile communication document TS 23.303 chapter 5.6.

At operation 1911, ProSe function 1905 may determine to trigger establishment of a WLAN direct group.

At operation 1913, the ProSe function 1905 may request WLAN direct group setup from the User Equipment A (UE-A) 1901.

At operation 1915, the User Equipment A (UE-A) 1901 may respond to the WLAN direct group setup of the ProSe function 1905.

At operation 1917, the ProSe function 1905 may request WLAN direct group setup of the ProSe function 1905.

At operation 1919, the User Equipment B (UE-B) 1903 may respond to the WLAN direct group setup of the ProSe function 1905.

At operation 1921, the User Equipment A (UE-A) 1901 and the User Equipment B (UE-B) 1903 may perform WLAN direct group establishment and WLAN direct communication.

It will be understood that the above-described embodiments are examples provided to aid in understanding of the contents of the present disclosure and do not limit the scope of the present disclosure. Accordingly, the scope of the present disclosure is defined by the appended claims, and it will be construed that all corrections and modifications derived from the meanings and scope of the following claims and the equivalent concept fall within the scope of the present disclosure.

What is claimed is:

1. A method for operating communication of an electronic device comprising:
determining whether a network is in a congestion state; and
changing a communication operation state if the network is in the congestion state.

2. The method of claim 1, wherein the changing the communication operation state comprises one of performing communication through another network, changing an antenna mode of the electronic device, and performing Device to Device (D2D) communication.

3. The method of claim 1, wherein the determining whether the network is in the congestion state comprises:
receiving a message or a signal regarding network congestion from the network; and
determining that the network is in the congestion state based on the received message or the received signal regarding the network congestion.

4. The method of claim 1, wherein the determining whether the network is in the congestion state comprises the electronic device monitoring the network, and determining that the network is in the congestion state through estimation of the congestion.

5. The method of claim 2, wherein the performing communication through another network comprises:
discovering another network;
determining a target operator; and
performing communication through the determined target operator.

6. The method of claim 5, wherein the determining the target operator comprises:
selecting the target operator; and
activating a detachable UICC that corresponds to the selected target operator.

7. The method of claim 5, wherein the determining the target operator comprises:
selecting the target operator;
determining whether a profile that corresponds to the selected target operator is present in an embedded UICC; and
activating the profile that corresponds to the selected target operator if the profile that corresponds to the selected target operator is present in the embedded UICC.

8. The method of claim 2, wherein the changing the antenna mode of the electronic device comprises:
determining whether the electronic device performs communication with multiple antennas if it is determined that the network is in the congestion state; and
operating the multiple antennas as a single antenna to perform the communication with the single antenna if the electronic device performs the communication with the multiple antennas.

9. The method of claim 2, wherein the changing the antenna mode of the electronic device comprises:
confirming a battery state of the electronic device;
determining whether a residual amount of the battery is equal to or less than a predetermined residual amount;
notifying an evolved Node B of the battery state if the residual amount of the battery is equal to or less than the predetermined residual amount; and
changing the antenna mode if an antenna mode change request is received from the evolved Node B.

10. The method of claim 2, wherein the performing the D2D communication comprises:
retrieving an ID of a peer that performs communication through the network or that intends to perform the D2D communication;
performing D2D scan using the retrieved peer ID;
determining whether the peer is located in a communication proximity to the electronic device; and
performing the D2D communication if it is determined that the peer is located in a communication proximity of the electronic device.

11. The method of claim 10, wherein the performing the D2D scan using the retrieved peer ID includes one or more of Proximity Service (ProSe) communication, WLAN communication, WLAN direct communication, and BT communication.

12. An electronic device comprising:
a communication module comprising communication circuitry; and
a processor,
wherein the processor is configured to determine whether a network is in a congestion state using processing circuitry configured as a network congestion determination module, and to change a communication operation state if the network is in the congestion state.

13. The electronic device of claim 12, wherein the processor is configured to change the communication operation state by performing one of communication through another network, changing an antenna mode of the electronic device, and performing Device to Device (D2D) communication.

14. The electronic device of claim 12, wherein if a message or a signal regarding network congestion is received through the communication circuitry, the processor is configured to determine whether the network is in the congestion state based on the message or the signal.

15. The electronic device of claim 12, wherein the processor is configured to monitor the network, to estimate a congestion situation of the network, and to determine whether the network is in the congestion state.

16. The electronic device of claim 13, wherein if another network is discovered through the communication circuitry, the processor is configured to determine a target operator (MNO), and to perform communication through the determined target operator to change the communication operation state.

17. The electronic device of claim 16, wherein the processor is configured to select the target operator, and to activate a detachable UICC corresponding to the selected target operator.

18. The electronic device of claim 16, wherein the processor is configured to select the target operator, to determine whether a profile corresponding to the selected target operator is present in an embedded UICC, and to activate the profile that corresponds to the selected target operator if the profile corresponding to the selected target operator is present in the embedded UICC.

19. The electronic device of claim 13, wherein the processor is configured to determine whether the electronic device performs communication with multiple antennas if it is determined that the network is in the congestion state, and to change the multiple antennas to a single antenna and to perform the communication with the single antenna if the electronic device performs the communication with the multiple antennas.

20. The electronic device of claim 13, wherein the processor is configured to confirm a battery state of the electronic device, to determine whether a residual amount of the battery is equal to or less than a predetermined residual amount, to notify an evolved Node B of the battery state if the residual amount of the battery is equal to or less than the predetermined residual amount, and to change the antenna mode if an antenna mode change request is received from the evolved Node B.

21. The electronic device of claim 13, wherein the processor is configured to retrieve an ID of a peer that performs communication through the network or that intends to perform the D2D communication, to perform a D2D scan using the retrieved peer ID, to whether the peer is located in a communication proximity of the electronic device, and to perform the D2D communication if it is determined that the peer is located in the communication proximity of the electronic device to change the communication operation state.

22. The electronic device of claim 21, wherein the processor is configured to perform the D2D scan using one or more of Proximity Service (ProSe) communication, WLAN communication, WLAN direct communication, and BT communication.
